(19) United States
(12) Patent Application Publication
(10) Pub. No.: US 2009/0318031 A1
(43) Pub. Date: Dec. 24, 2009

(54) Transfer plug with an attractive-shaped accessory

(75) Inventor: Johnson Wu, Tainan Hsien (TW)

Correspondence Address: BACON & THOMAS, PLLC, 625 SLATERS LANE, FOURTH FLOOR, ALEXANDRIA, VA, 22314-1176, US

(73) Assignee: Holageo Enterprise Co., Ltd., Tainan Hsien (TW)

(21) Appl. No.: 12/213,635

(22) Filed: Jun. 23, 2008

(51) Int. Cl. H01R 25/00

(52) U.S. Cl. 439/638

(57) ABSTRACT

A transfer plug or a socket and the like with an attractively-shaped accessory includes a attractively-shaped accessory combined with an outer surface of the transfer plug or the socket and the like for giving an ornamental appearance. Further, the attractively-shaped accessory is provided with an electronic appliance so that the transfer plug or the socket and the like may appear lively and attractive and practical as well. Besides, the attractively-shaped accessory can be replaced with another one with a different shape from the transfer plug or the socket and the like, enabling a consumer to always change it for boosting interest and atmosphere.

### BACKGROUND OF THE INVENTION

1. Field of the Invention

This invention relates to a transfer plug or a socket and the like, particularly to one attached with an attractively-shaped accessory fixed on one or plural surfaces, making the transfer plug looking lively, attractive, intriguing and practical as well.

2. Description of the Prior Art

Generally, conventional transfer plugs or sockets and the like are shaped square or rectangular, and their surfaces are mostly flat, appearing commonplace and unattractive, and this tendency has persisted for long, with no decorative means added to them.

### SUMMARY OF THE INVENTION

This invention has been devised to offer a transfer plug or a socket and the like provided with both a decorative appearance and an electronic function.

The main feature of the invention is an attractively-shaped accessory combined on the outer surface of the transfer plug or the socket and the like, and the accessory is provided with an electronic appliance so that the transfer plug or the socket and the like may have both an ornamental appearance and an electronic function as will.

### BRIEF DESCRIPTION OF DRAWINGS

This invention will be better understood by referring to the accompanying drawings, wherein:

FIG. 1 is a perspective view of a first preferred embodiment of a transfer plug with an attractively-shaped accessory in the present invention;

FIG. 2 is an exploded perspective view of the first preferred embodiment of a transfer plug with an attractive-shaped accessory in the present invention;

FIG. 3 is a perspective view of a second preferred embodiment of a plug with an attractively-shaped accessory in the present invention;

FIG. 4 is a perspective view of a third preferred embodiment of a transfer plug with an attractively-shaped accessory in the present invention

FIG. 5 is a perspective view of a fourth preferred embodiment of a transfer plug with an attractively-shaped accessory in the present invention;

FIG. 6 is a perspective view of a fifth preferred embodiment of a transfer plug with an attractively-shaped accessory in the present invention;

FIG. 7 is an exploded perspective view of a sixth preferred embodiment of a socket with an attractively-shaped accessory in the present invention;

FIG. 8 is a perspective view of the sixth preferred embodiment in the present invention; and

FIG. 9 is an upper view of the sixth preferred embodiment in the present invention.

### DETAILED DESCRIPTION OF THE PREFERRED EMBODIMENTS

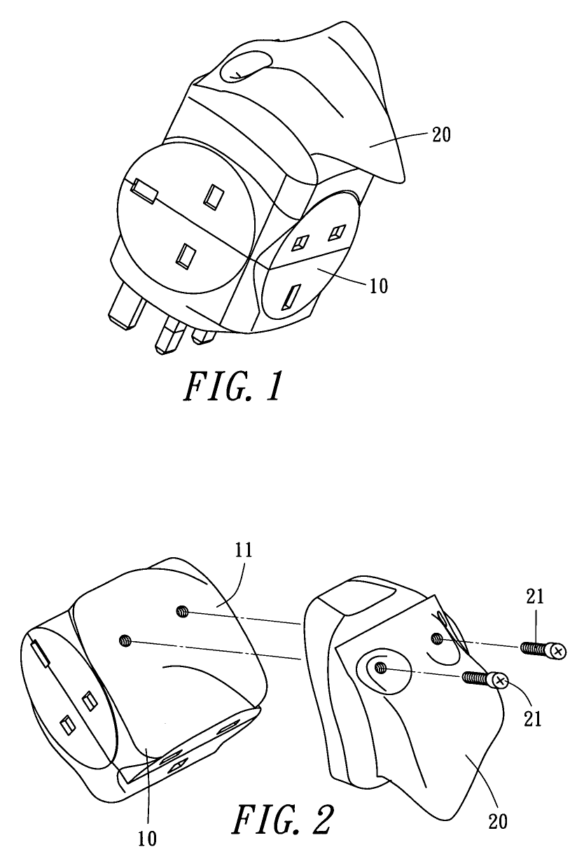

A first preferred embodiment of a transfer plug 10 with an attractively-shaped accessory in the present, as shown in FIGS. 1 and 2, includes a front surface 11, an attractively-shaped accessory 20 combined with the front surface 11 by means of screws 21 or a supersonic process or male and female threads. Thus the attractively-shaped accessory 20 fixed on the front surface of the plug enables the plug 10 look like decorative and intriguing.

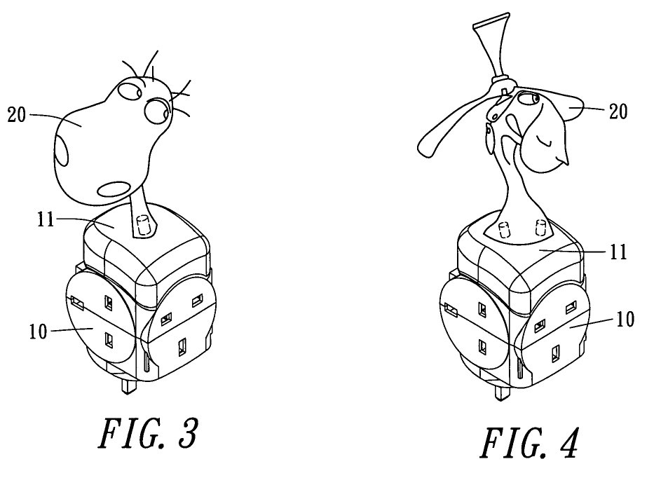

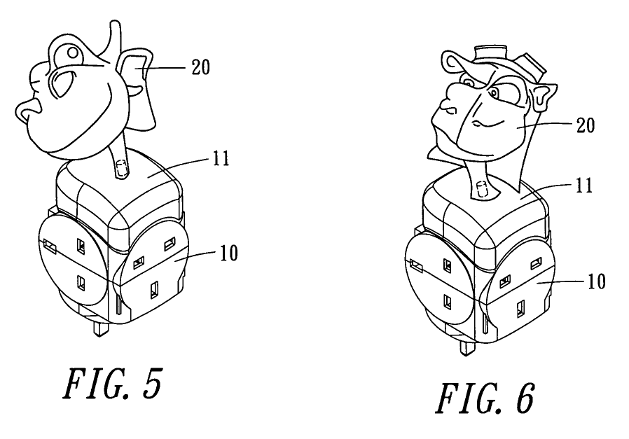

The attractively-shaped accessory 20 can have various shapes, as shown in FIGS. 3-6, possibly being the shape of any of twelve animals of Chinese culture, optionally selected by a user according to his/her taste.

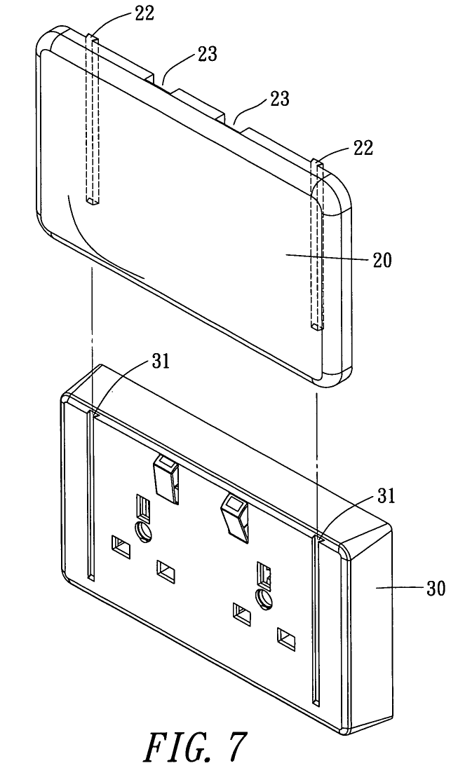

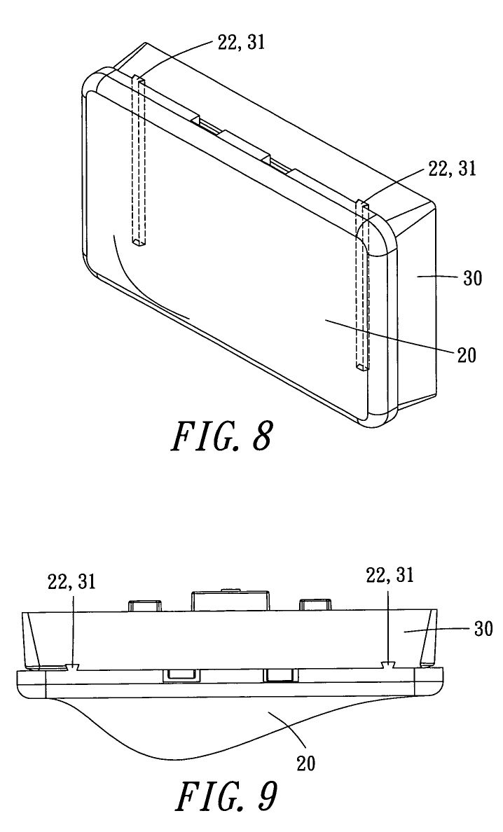

Next, FIGS. 7, 8 and 9 show the attractively-shaped accessory applied to a socket with switches 30, and the socket with switches 30 is provided with plural vertical slide grooves 31 in its outer surface, and the attractively-shaped accessory 20 is provided with plural slide rails 22 engaging with the slide grooves 31 and located on the outer surface.

If a plug is to be inserted in the socket with switches 30, the attractively-shaped accessory 20 is pulled up to permit the plug pushed into the socket with switches. When the switches of the socket 30 are to be pressed, the attractively-shaped accessory has the notches 23 to face to the switches so as to be pressed.

In addition, the function of the attractively-shaped accessory 20 can be augmented by adding therein some electronic appliance such as a sound controller, a light controller, a lantern with s running horses picture, etc. The power needed by this added electronic appliance can be got from an induction charger that is wrapped with insulating material and fixed in the interior of the socket 30. Further, the induction charger is provided with a power receiver to enable the attractively-shaped accessory can get the power generated by the induction charger to be supplied to the electronic appliance.

While the preferred embodiment of the invention has been described above, it will be recognized and understood that various modifications may be made therein and the appended claims are intended to cover all such modifications that may fall within the spirit and scope of the invention.

What is claimed is:

1. A transfer plug or a socket and the like comprising;
An attractively-shaped accessory combined on an outer surface of said plug or said socket and the like for making said transfer plug or said socked and the like look decorative and attractive.

2. The transfer plug or the socket and the like as claimed in claim 1, wherein said attractively-shaped accessory is combined with said transfer plug or said socket and the like by means of screws.

3. The transfer plug or the socket and the like as claimed in claim 1. wherein said attractively-shaped accessory and said transfer plug or said socket and the like are combined with each other by means of engagement.

4. The transfer plug or the socket and the like as claimed in claim 1, wherein said transfer plug or said socket and the like is combined with each other by means of a supersonic process.

5. The transfer plug or the socket and the like as claimed in claim 1, wherein said transfer plug or said socket and the like are combined with each other by means of male and female threads.

6. The transfer plug or the socket and the like as claimed in claim 1, wherein said attractively-shaped accessory is further added in its interior with an electronic appliance, making said attractively-shaped accessory more convenient and functional.

7. The transfer plug or the socket and the like as claimed in claim 6, wherein an induction charger with its outer surface insulated is further provided in an interior of said socket with switches, for supplying said electronic appliance in said attractively-shaped accessory with power, and said induction charger is added with a power receiver, so said attractively-shaped accessory may get power from said induction charger for said electronic appliance, when attractively-shaped accessory is installed on an outer surface of said socket with switches.
